(19) United States
(12) Patent Application Publication
(10) Pub. No.: US 2026/0097826 A1
(43) Pub. Date: Apr. 9, 2026

(54) Method for Automatically Shifting into a Suitable Gear for Start-Up, Control Device, Computer Program Product, Computer-Readable Medium, Bicycle

(71) Applicant: ZF Friedrichshafen AG, Friedrichshafen (DE)

(72) Inventors: Alexander Jungaberle, Schlier (DE); Uwe Schraff, Markdorf (DE); Markus Wallner, Friedrichshafen (DE)

(21) Appl. No.: 19/115,127

(22) PCT Filed: Sep. 26, 2022
(86) PCT No.: PCT/EP2022/076615

§ 371 Date: Mar. 25, 2025

(51) Int. Cl. B62M 9/133; B62J 45/411; B62J 45/412; B62J 45/415; B62M 6/50; B62M 25/08

(52) U.S. Cl. CPC B62M 9/133; B62J 45/411; B62J 45/412; B62J 45/4152; B62M 25/08; B62M 6/50

(57) ABSTRACT

A method for automatically shifting into a suitable gear of a bicycle transmission of a bicycle for starting off, the suitable gear enabling a cadence in a range from 60 to 120 rotations per minute, the method being carried out when starting-off assist is activated. The method includes automatically shifting into the suitable gear when, simultaneously: a current speed of the bicycle reaches or falls below a speed threshold value, a current crank torque of the bicycle reaches or exceeds a crank torque threshold value, a current gear of the bicycle deviates from a gear threshold value, and either i) the current inclination angle of the bicycle reaches or exceeds a first inclination angle threshold value, or ii) the current inclination angle of the bicycle falls below a second inclination angle threshold value.

### CROSS-REFERENCE TO RELATED APPLICATION

The present application is a nationalization of PCT/EP2022/076615 filed in the European Patent Office on Sep. 26, 2022, the entirety of which is incorporated by reference for all purposes.

### FIELD OF THE INVENTION

The invention relates generally to a method for automatically shifting into a suitable gear for starting off, to a control device, to a computer program product, to a computer-readable medium, and to a bicycle.

### BACKGROUND

Bicycles having an electrical (auxiliary) propulsion means, for example, e-bikes and pedelecs, are becoming increasingly popular. Sporty electric mountain bikes (eMTB), which have torques up to 110 Nm (Newton-meter) at the motor output and a maximum power up to 750 W (Watt), are also in use. These enable riding even on extreme uphill gradients of more than 25°.

Derailleur gears are widely used in the field of eMTBs. These have the disadvantage, however, that a gear shift cannot be carried out at a standstill. If the rider is in an unfavorable gear when starting off on a steep hillside, which gear enables a cadence that is too low, the full system power is not available. The rider must therefore lift the rear wheel and manually shift the bicycle into the optimal starting-off gear. This can become very difficult due to ambient conditions, for example on steep terrain, and due to the weight of the bicycle, of, for example, over 20 kg.

DE 10 2018 208 380 describes a multi-speed transmission for a bicycle, which can be shifted under load both into higher gear steps and into lower gear steps.

### SUMMARY OF THE INVENTION

The problem addressed by the invention is that of avoiding the disadvantages mentioned at the outset. This problem is solved by a method for automatically shifting into a suitable gear for starting off, by a control device, by a computer program product, by a computer-readable medium, and by a bicycle. Developments are described in the dependent claims and can be gathered from the following description.

In a method for automatically shifting into a gear of a bicycle transmission that is suitable for starting off, wherein the suitable gear enables a cadence in the range from 60 rpm (revolutions per minute) to 120 rpm, when starting-off assist is activated, initially a current speed, a current inclination angle, a current crank torque, and a current gear of the bicycle are determined. Then, the current speed (v) is compared with a speed threshold value (vlim). The current inclination angle is compared with at least one inclination angle threshold value. The current crank torque is compared with a crank torque threshold value. The current gear is compared with a gear threshold value. A shift into the suitable gear is then automatically carried out when the current speed reaches or falls below the speed threshold value, and when the current crank torque simultaneously reaches or exceeds the crank torque threshold value, and when the current gear simultaneously deviates from the gear threshold value, and either when the current inclination angle simultaneously reaches or exceeds a first inclination angle threshold value or when the current inclination angle simultaneously falls below a second inclination angle threshold value.

The term “bicycle” refers, in this case, to all bicycles which have both an electrical (auxiliary) propulsion means as well as a drive operated by muscle power, wherein the bicycle is propelled either purely by muscle power, purely electrically, or, in the hybrid mode, both by muscle power and electrically. In any case, the bicycle has a crank unit and an electrical propulsion unit. The bicycle is, for example, an e-bike, a (high-speed) pedelec, an eMTB, a velomobile, a cargo bike, or another suitable vehicle.

The method relates to shifting a bicycle transmission. The bicycle transmission is, for example, a multi-speed transmission of planetary design. Other transmission designs with which it is possible to shift under load are also possible, however. The bicycle transmission is operatively connected to the electrical propulsion unit. The bicycle transmission is also operatively connected to the crank unit. The bicycle transmission is a bottom bracket transmission or a hub gear.

By the method, a shift into the suitable gear is automatically carried out. The suitable gear is the gear that enables a cadence in the range from 60 rpm to 120 rpm. This cadence range also covers, in particular, a cadence range from 60 rpm to 100 rpm. This corresponds to the ideal cadence for humans, at which propelling the bicycle is perceived as being hardly strenuous and even effortless. In bicycles having an electric motor connection at the transmission input, for example in pedelecs, the electric motor is also dependent on the current gear ratio and is optimized for human cadence.

The method is carried out only when the starting-off assist is activated. This means, if the bicycle rider has not activated the electrical (auxiliary) propulsion means, the method is not carried out. “Starting-off assist” is understood to mean that the propulsive power for starting off with the bicycle is made available by a combination of muscle power and electrical propulsive force. The rider therefore actuates the crank unit, and the electric motor simultaneously provides propulsive force.

In a first step of the method, the current speed of the bicycle, a current inclination angle of the bicycle, a current crank torque of the bicycle, and a current gear of the bicycle are determined. These determinations preferably take place simultaneously. It is also possible to determine these values one after the other, however. The aforementioned values are preferably determined by suitable sensors. These sensors are installable, for example, directly on the bicycle. Each of the required sensors is connected to the control device on the bicycle. These respective connections are capable of signal exchange, i.e., data and signals are exchangeable between the control device and the respective sensors. Alternatively, it is possible that individual sensors or all sensors are present in one external unit, for example, in a mobile terminal such as a smartphone, a smartwatch, a fitness tracker, or the like. When the sensor data of the mobile terminal are to be used, data and signals are exchanged between the external unit and the control device of the bicycle, for example, via a radio link or by hard-wired communication. Alternatively, or additionally, it is possible that any or all of these current values are determined by calculation models, wherein sensor data are the basis; for example, the current speed is calculatable by sensor data of an acceleration sensor or by sensor data of a position determination system such as GPS.

In a second step of the method, the current speed is then compared with the speed threshold value. As a result, it is established whether the bicycle is standing still, or is nearly standing still, or whether the bicycle has a high speed. The speed threshold value is stored in a memory device in the control device of the bicycle. This speed threshold value is preferably stored by the manufacturer. The speed threshold value is selected such that it corresponds to a slow speed of the bicycle, so that a standstill or a near standstill of the bicycle is inferable.

The term “threshold” or “threshold value” does not refer to a global limit value which cannot be physically exceeded or fallen below. Rather, this is a certain value which a user has established.

In a third step of the method, which is carried out simultaneously with or after the second step, the current inclination angle is compared with the at least one inclination angle threshold value. As a result, it is established whether the bicycle is located on a steep uphill gradient, a moderate uphill gradient, or a downhill gradient. The at least one inclination angle threshold value is stored in the memory device of the control device of the bicycle. The at least one inclination angle threshold value is preferably stored by the manufacturer. A first inclination angle threshold value is selected such that it corresponds to an uphill gradient. A second inclination angle threshold value is selected such that it corresponds to a downhill gradient, which second inclination angle threshold value is negative by definition. Another inclination angle threshold value is selectable, which corresponds to a moderate uphill gradient, in which case the first inclination angle threshold value then corresponds to a steep uphill gradient.

In a fourth step of the method, which is carried out simultaneously with or after the second step and/or the third step, the current crank torque is compared with the crank torque threshold value. As a result, it is established whether the rider wants to start off. The crank torque threshold value is stored in the memory device of the control device of the bicycle. The crank torque threshold value is preferably stored by the manufacturer. The crank torque threshold value is selected such that it represents a slow actuation of the pedals by the rider.

In a fifth step of the method, which is carried out simultaneously with or after the second step and/or the third step and/or the fourth step, the current gear is compared with a gear threshold value. As a result, it is established whether a gear which is too low or too high has been selected. The gear threshold value is dynamic. This means that it changes from riding situation to riding situation. The gear threshold value always corresponds to the gear which is the suitable gear for starting off with the bicycle in the particular riding situation. This gear threshold value is determined and established by a calculation model. In so doing, it is determined starting from the optimal cadence, which is to be in the range from 60 rpm to 120 rpm, which gear enables this cadence when starting-off assist has been selected.

In a sixth step, a shift into the suitable gear is automatically carried out. This takes place by the transmission actuator system, which is activated by the control device. The shift into the suitable gear is carried out when the current speed reaches or falls below the speed threshold value, when the current crank torque simultaneously reaches or exceeds the crank torque threshold value, when the current gear simultaneously deviates from the gear threshold value, and either when the current inclination angle simultaneously reaches or exceeds the first inclination angle threshold value or when the current inclination angle simultaneously falls below the second inclination threshold angle.

Due to this alternative, starting off on an uphill gradient and starting off on a downhill gradient are assisted. On the uphill gradient, the shift into the suitable gear makes it easier for the rider to start off, such that the rider has to apply less muscle power. On the downhill gradient, the shift into the suitable gear makes it easier for the rider to start off as the rider does not pedal “into thin air.”

According to one development, the suitable gear is at least one gear step lower than the current gear when the current inclination angle reaches or exceeds the first inclination angle threshold value. As a result, starting off on an uphill gradient is carried out in the most suitable gear. The rider therefore has to apply less muscle power and exert themself to a lesser extent in order to start off.

Alternatively, the suitable gear is at least one gear step higher than the current gear when the current inclination angle falls below the second inclination angle threshold value. As a result, starting off on a downhill gradient is carried out in the most suitable gear. The rider therefore does not pedal “into thin air” when they start off on a downhill gradient.

According to one development, a current cadence is also determined, which current cadence is compared with a cadence threshold interval, wherein the shift into the suitable gear is carried out when the current cadence is outside the cadence threshold interval. The cadence threshold interval corresponds to a cadence in the range from 60 rpm to 120 rpm. Due to the additional determination of the current cadence, the shift into the suitable gear is validated. It is therefore established whether the shift actually results in a cadence for the rider which is within the cadence threshold interval.

A control device for a bicycle is connectable to the bicycle transmission of the bicycle for signal exchange. The control device is connectable to at least one sensor for signal exchange. The control device includes means for carrying out the method, which has been described above in the preceding description. The control device is, for example, a domain ECU (electronic control unit) or an ECU.

A connection which permits an exchange of signals is one in which data and signals are exchangeable between the connection partners. For this purpose, each connection partner has a corresponding interface. The data and signal transmission is carried out either in a hard-wired manner or a wireless manner.

When the control device is used in a bicycle, the control device is connected to the bicycle transmission, specifically to the actuator system of the bicycle transmission, for signal exchange, such that the control device activates the actuator system. The control device therefore initiates an upshift or a downshift into other gear steps. In addition, the control device senses which gear of the bicycle transmission is engaged.

When the control device is used in a bicycle, the control device is connected to at least one sensor for signal exchange. The control device receives data regarding the speed, the crank torque, the inclination angle, and, optionally, the cadence, from the sensors. For example, the control device is connectable to a speed sensor, to a crank torque sensor, to an inclination angle sensor, and/or to a mobile terminal for signal exchange. When the control device is connected to the mobile terminal, the control device receives data and signals from the mobile terminal, which data and signals are acquired by the sensors in the mobile terminal. For example, the control device uses the inclination angle data, the speed data, the GPS data, or the like, of the mobile terminal.

A computer program product includes commands which, when the program is run by the above-described control device, prompt the control device to carry out the above-described method.

A computer-readable medium includes commands which, when run by the above-described control device, prompt the control device to carry out the above-described method. The computer-readable medium is, for example, a data carrier or a downloadable data stream.

The bicycle includes the bicycle transmission and the control device, which has been described above in the preceding description. The transmission is connected to the control device for signal exchange. The control device therefore activates the actuator system of the transmission, such that the engagement or disengagement of a gear and, therefore, the switch between gear steps, can be initiated. The bicycle therefore carries out the above-described method for automatically shifting into a gear of the bicycle transmission that is suitable for starting off.

The bicycle additionally includes the crank unit and the electrical propulsion unit, wherein both the electrical propulsion unit, which includes, for example, an electric motor and an energy store, as well as the crank unit can be operatively connected to the bicycle transmission. In addition, the bicycle includes multiple sensors which are connected to the control device for signal exchange, for example, speed sensors, crank torque sensors, inclination angle sensors, cadence sensors, and/or mobile terminals.

### BRIEF DESCRIPTION OF THE DRAWINGS

Exemplary embodiments of the invention are shown in the figures. Wherein:

FIG. 1 shows a schematic view of a bicycle according to one exemplary embodiment,

FIG. 2 shows a schematic view of a bicycle according to another exemplary aspect of the embodiment,

FIG. 3 shows a schematic view of the bicycle shown in FIG. 1 or FIG. 2 in a first riding situation,

FIG. 4 shows a schematic view of a method sequence for automatically shifting into a suitable gear for starting off for the riding situation shown in FIG. 3,

FIG. 5 shows a schematic view of the bicycle shown in FIG. 1 or FIG. 2 in a second riding situation,

FIG. 6 shows a schematic view of a method sequence for automatically shifting into a suitable gear for starting off for the riding situation shown in FIG. 5,

FIG. 7 shows a schematic view of the bicycle shown in FIG. 1 or FIG. 2 in a third riding situation,

FIG. 8 shows a schematic view of a method sequence for automatically shifting into a suitable gear for starting off for the riding situation shown in FIG. 7.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

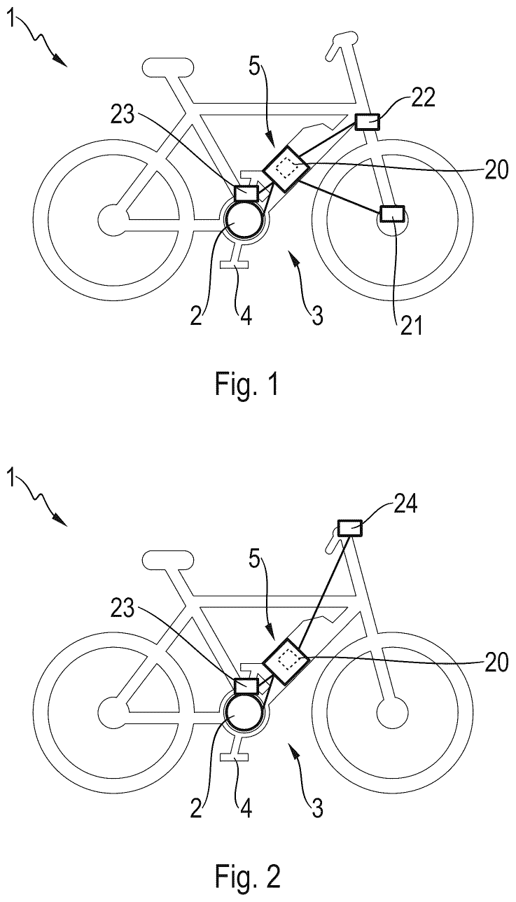

FIG. 1 shows a schematic view of a bicycle 1 according to one exemplary embodiment. The bicycle 1 is an e-bike or a pedelec or, in particular, an eMTB. The bicycle 1 has a crank unit, only the pedals 4 of which are shown for the sake of greater clarity. The bicycle 1 also has an electrical propulsion unit 3, the electric motor (not illustrated) of which is located, for example, in the region of the bottom bracket. The electrical propulsion unit 3 has an electrical energy store 5, which is connected to the electric motor. The electrical energy store 5 supplies the electric motor (operated as a motor) with electrical energy or is supplied with electrical energy by the electric motor (operated as a generator).

The bicycle 1 also has a bicycle transmission 2, which is, for example, a multi-speed planetary transmission. The bicycle transmission 2 is a bottom bracket transmission. The bicycle transmission 2 is operatively connected to the electrical propulsion unit 3 and to the crank unit. The bicycle 1 is therefore propelled either purely by muscle power, purely electrically, or both by muscle power and electrically.

The bicycle 1 includes a control device 20, which is connected to the bicycle transmission 2, specifically to the actuator system of the bicycle transmission 2, for signal exchange.

In addition, the bicycle 1 has multiple sensors, which are connected to the control device 20 for signal exchange. The bicycle 1 has a speed sensor 21, which is designed to determine the current speed of the bicycle 1. The speed sensor 21 transmits this value to the control device 20.

The bicycle 1 has an inclination angle sensor 22, which is designed to determine the current inclination angle of the bicycle 1. The inclination angle sensor 22 transmits this value to the control device 20.

The bicycle 1 has a crank torque sensor 23, which is designed to determine the current crank torque of the bicycle 1. The crank torque sensor 23 transmits this value to the control device 20.

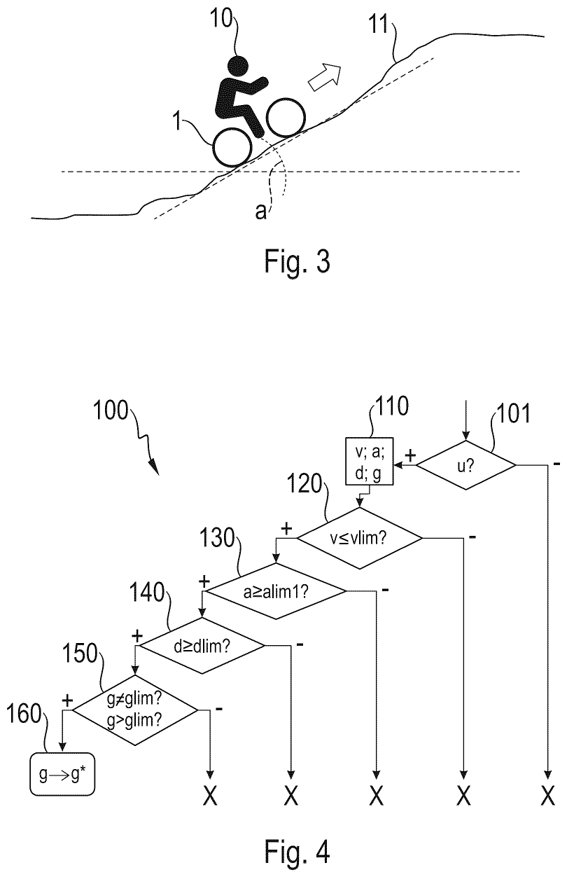

Proceeding from the values which have been determined using sensors, a method for automatically shifting into a suitable gear of the bicycle transmission 2 for starting off is carried out, as shown in the method flow diagrams in FIGS. 4, 6, and 8 for various riding situations according to FIGS. 3, 5, and 7.

FIG. 2 shows a schematic view of a bicycle 1 according another exemplary aspect of the embodiment. The bicycle 1 shown in FIG. 2 differs from the bicycle shown in FIG. 1 only in that, instead of the speed sensor and the inclination angle sensor, a mobile terminal 24, for example a smartphone, is provided. This mobile terminal 24 is connected to the control device 20 for signal exchange. The mobile terminal is configured to determine a current inclination angle of the bicycle 1 and a current speed of the bicycle 1. The mobile terminal 24 transmits these values to the control device 20.

Proceeding from the values which have been determined using sensors, the method for automatically shifting into a gear of the bicycle transmission 2 that is suitable for starting off is also carried out with this bicycle configuration, as is shown in the method flow diagrams in FIGS. 4, 6, and 8 for various riding situations according to FIGS. 3, 5, and 7.

FIG. 3 shows a schematic view of the bicycle 1 shown in FIG. 1 or FIG. 2 in a first riding situation. The rider 10 would like to start off on a steep uphill gradient with the bicycle 1 along the route 11 in the riding direction indicated by the block arrow. The steepness of the uphill gradient of the route 11 is expressed as the current inclination angle a of the bicycle 1. The rider 10 has activated the starting-off assist, so that the method shown in FIG. 4 is carried out.

FIG. 4 shows a schematic view of a method sequence for automatically shifting into a suitable gear g* for starting off for the riding situation shown in FIG. 3. The method 100 has a total of six steps 110, 120, 130, 140, 150, 160 as well as an initial step 101. If values are checked or values are compared in one of the steps 110, 120, 130, 140, 150, 160 or in the initial step, the method 100 is either terminated when the check or comparison yields a negative result, which is indicated in the figure by a minus sign, or the method 100 continues, which is indicated in the figure by a plus sign. If the method 100 is terminated, this is indicated in the figure by an X.

The initial step 101 is a check to determine whether the starting-off assist u is activated. If the starting-off assist u is not activated, the method 100 is terminated. If the starting-off assist u is activated, the first step 110 of the method 100 follows. In the first step 110 of the method 100, a current speed v, a current inclination angle a, a current crank torque d, and a current gear g of the bicycle 1 are determined by sensors.

In the second step 120 of the method 100, which follows the first step 110, the current speed v is compared with a speed threshold value vlim. If the current speed v is greater than the speed threshold value vlim, the method 100 is terminated. If the current speed v is less than or equal to the speed threshold value vlim, the method 100 is continued.

In a third step 130 of the method 100, which follows the second step 120 but which, alternatively, is also carried out simultaneously with the second step 120, the current inclination angle a is compared with a first inclination angle threshold value alim1. If the current inclination angle a is less than the first inclination angle threshold value alim1, the method 100 is terminated. If the current inclination angle a is greater than or equal to the first inclination angle threshold value alim1, the method 100 is continued.

In a fourth step 140 of the method 100, which follows the third step 130 but which, alternatively, is also carried out simultaneously with the third step 130, the current crank torque d is compared with a crank torque threshold value dlim. If the current crank torque d is less than the crank torque threshold value dlim, the method 100 is terminated. If the current crank torque d is greater than or equal to the crank torque threshold value dlim, the method 100 is continued.

In a fifth step 150 of the method 100, which follows the fourth step 140 but which, alternatively, is also carried out simultaneously with the fourth step 140, the current gear g is compared with the gear threshold value glim. If the current gear g is equal to the gear threshold value glim, the method 100 is terminated. If the current gear g is lower than the gear threshold value glim, the method 100 is also terminated. If the current gear g is not equal to the gear threshold value glim and if the current gear g is higher than the gear threshold value glim, the method 100 is continued.

In a sixth step 160 of the method 100, which follows the fifth step 150, a shift from the current gear g into the suitable gear g* for starting off is automatically carried out. In this exemplary aspect of the embodiment, the suitable gear g* corresponds to a gear which is at least one gear step lower than the current gear g. As a result, it is possible for the rider to effortlessly start off on the steep uphill gradient shown in FIG. 3. The rider therefore has to apply less muscle power in order to start off.

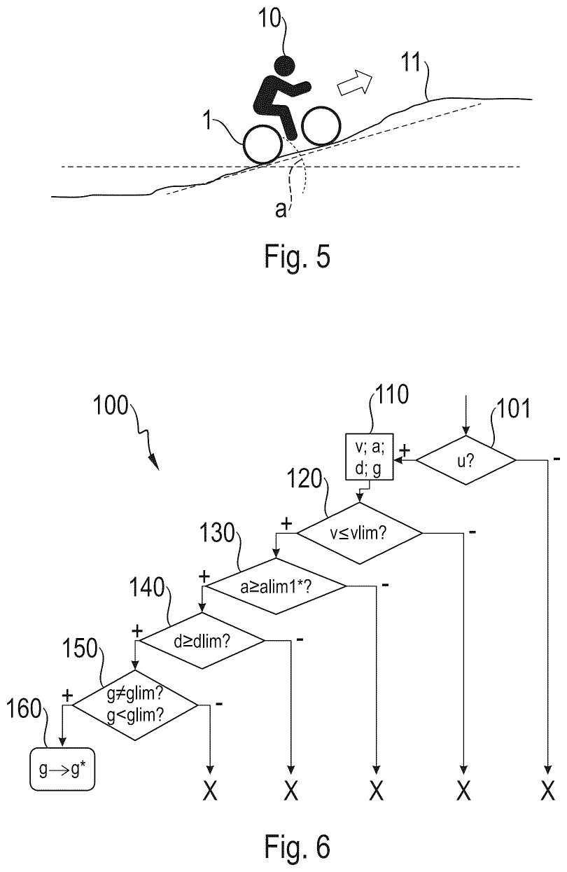

FIG. 5 shows a schematic view of the bicycle 1 shown in FIG. 1 or FIG. 2 in a second riding situation. The rider 10 would like to start off on a moderate uphill gradient with the bicycle 1 along the route 11 in the riding direction indicated by the block arrow. The steepness of the uphill gradient of the route 11 is expressed as the current inclination angle a of the bicycle 1. The rider 10 has activated the starting-off assist, so that the method shown in FIG. 6 is carried out.

FIG. 6 shows a schematic view of a method sequence for automatically shifting into a suitable gear g* for starting off for the riding situation shown in FIG. 5. The method 100 has a total of six steps 110, 120, 130, 140, 150, 160 as well as an initial step 101. The method 100 in FIG. 6 differs from the method 100 shown in FIG. 4 only with respect to the third step 130 and the fifth step 150, and therefore the remaining steps 101, 110, 120, 140 will not be described again.

The initial step 101, the first step 110, and the second step 120 are identical to the steps 101, 110, 120 described with reference to FIG. 4.

In the third step 130 of the method 100, which follows the second step 120 but which, alternatively, is also carried out simultaneously with the second step 120, the current inclination angle a is compared with another first inclination angle threshold value alim1*. If the current inclination angle a is less than the other first inclination angle threshold value alim1*, the method 100 is terminated. If the current inclination angle a is greater than or equal to the other first inclination angle threshold value alim1*, the method 100 is continued. The first inclination angle threshold value alim1 shown in FIG. 4 differs from the other first inclination angle threshold value alim1* shown in FIG. 6 in that the first inclination angle threshold value alim1 relates to a greater inclination angle than the other first inclination angle threshold value alim1*. The other first inclination angle threshold value alim1* therefore represents a moderate uphill gradient.

The fourth step 140 is identical to the fourth step 140 shown in FIG. 4.

In a fifth step 150 of the method 100, which follows the fourth step 140 but which, alternatively, is also carried out simultaneously with the fourth step 140, the current gear g is compared with the gear threshold value glim. If the current gear g is equal to the gear threshold value glim, the method 100 is terminated. If the current gear g is higher than the gear threshold value glim, the method 100 is also terminated. If the current gear g is not equal to the gear threshold value glim and if the current gear g is lower than the gear threshold value glim, the method 100 is continued.

In a sixth step 160 of the method 100, which follows the fifth step 150, a shift from the current gear g into the suitable gear g* for starting off is automatically carried out. In this exemplary aspect of the embodiment, the suitable gear g* corresponds to a gear which is at least one gear step higher than the current gear g. As a result, it is possible for the rider to effortlessly start off on the moderate uphill gradient shown in FIG. 5. The suitable gear g* which is shifted into by the method 100 in FIG. 6 is preferably higher than the suitable gear g* which is shifted into by the method 100 in FIG. 4.

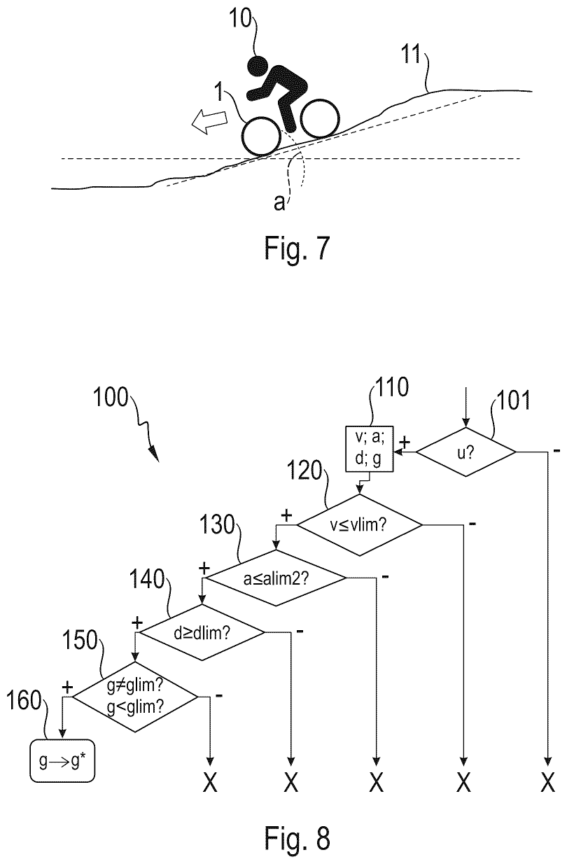

FIG. 7 shows a schematic view of the bicycle 1 from FIG. 1 or FIG. 2 in a third riding situation. The rider 10 would like to start off on a downhill gradient with the bicycle 1 along the route 11 in the riding direction indicated by the block arrow. The steepness of the downhill gradient of the route 11 is expressed as the current inclination angle a of the bicycle 1. The rider 10 has activated the starting-off assist, so that the method shown in FIG. 8 is carried out.

FIG. 8 shows a schematic view of a method sequence for automatically shifting into a suitable gear g* for starting off for the riding situation shown in FIG. 7. The method 100 has a total of six steps 110, 120, 130, 140, 150, 160 as well as an initial step 101. The method 100 in FIG. 8 differs from the method 100 shown in FIG. 4 only with respect to the third step 130 and the fifth step 150, and therefore the remaining steps 101, 110, 120, 140 will not be described again.

The initial step 101, the first step 110, and the second step 120 are identical to the steps 101, 110, 120 described with reference to FIG. 4.

In the third step 130 of the method 100, which follows the second step 120 but which, alternatively, is also carried out simultaneously with the second step 120, the current inclination angle a is compared with a second inclination angle threshold value alim2. If the current inclination angle a is greater than the second inclination angle threshold value alim2, the method 100 is terminated. If the current inclination angle a is less than or equal to the second inclination angle threshold value alim2, the method 100 is continued. The first inclination angle threshold value alim1 shown in FIG. 4 differs from the second inclination angle threshold value alim2 shown in FIG. 8 in that the first inclination angle threshold value alim1 relates to an uphill gradient and the second inclination angle threshold value alim2 relates to a downhill gradient. The second inclination angle threshold value alim2 is negative by definition.

The fourth step 140 is identical to the fourth step 140 shown in FIG. 4.

In a fifth step 150 of the method 100, which follows the fourth step 140 but which, alternatively, is also carried out simultaneously with the fourth step 140, the current gear g is compared with the gear threshold value glim. If the current gear g is equal to the gear threshold value glim, the method 100 is terminated. If the current gear g is higher than the gear threshold value glim, the method 100 is also terminated. If the current gear g is not equal to the gear threshold value glim and if the current gear g is lower than the gear threshold value glim, the method 100 is continued.

In a sixth step 160 of the method 100, which follows the fifth step 150, a shift from the current gear g into the suitable gear g* for starting off is automatically carried out. In this exemplary aspect of the embodiment, the suitable gear g* corresponds to a gear which is at least one gear step higher than the current gear g. As a result, it is possible for the rider to effortlessly start off on the downhill gradient shown in FIG. 7. The rider therefore does not need to pedal “into thin air” when starting off.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 bicycle
2 bicycle transmission
3 electrical propulsion unit
4 pedal
5 energy store
10 rider
11 route
20 control device
21 speed sensor
22 inclination angle sensor
23 crank torque sensor
24 mobile terminal
100 method
101 initial step
110 first step
120 second step
130 third step
140 fourth step
150 fifth step
160 sixth step
a current inclination angle
alim1 first inclination angle threshold value
alim1* another first inclination angle threshold value
alim2 second inclination angle threshold value
d current crank torque
dlim crank torque threshold value
g current gear
glim gear threshold value
g* suitable gear
k current cadence
klim cadence threshold interval
u starting-off assist
v current speed
vlim speed threshold value
X termination of the method

1-7. canceled

8. A method (100) for automatically shifting into a suitable gear (g*) of a bicycle transmission (2) of a bicycle (1), the suitable gear (g*) being suitable for starting off, the suitable gear (g*) enabling a cadence (k) in a range from 60 rpm to rpm, the method comprising, when starting-off assist (u) is activated:
determining a current speed (v), a current inclination angle (a), a current crank torque (d), and a current gear (g) of the bicycle (1);
comparing the current speed (v) with a speed threshold value (vlim);
comparing the current inclination angle (a) with at least one inclination angle threshold value (alim1, alim1*, alim2);
comparing the current crank torque (d) with a crank torque threshold value (dlim);
comparing the current gear (g) with a gear threshold value (glim);
automatically shifting into the suitable gear (g*) when, simultaneously:
the current speed (v) reaches or falls below the speed threshold value (vlim);
the current crank torque (d) reaches or exceeds the crank torque threshold value (dlim);
the current gear (g) deviates from the gear threshold value (glim); and either:
i) the current inclination angle (a) reaches or exceeds a first inclination angle threshold value (alim1, alim1*); or
ii) the current inclination angle (a) falls below a second inclination angle threshold value (alim2).

9. The method (100) of claim 8, wherein the suitable gear (g*) is at least one gear step lower than the current gear (g) when the current inclination angle (a) reaches or exceeds the first inclination angle threshold value (alim1, alim1*), and wherein the suitable gear (g*) is at least one gear step higher than the current gear (g) when the current inclination angle (a) falls below the second inclination angle threshold value (alim2).

10. The method (100) of claim 8, further comprising, when starting-off assist (u) is activated:
determining a current cadence (k); and
comparing the current cadence with a cadence threshold interval (klim),
wherein the shifting into the suitable gear (g*) is automatically carried out when the current cadence (k) is also outside the cadence threshold interval (klim).

11. A control device (20) for the bicycle (1), wherein the control device (20) is connectable to the bicycle transmission (2) of the bicycle (1) for signal exchange, wherein the control device (20) is connectable to at least one sensor for signal exchange, and wherein the control device (20) carries out the method (100) of claim 8.

12. A computer program product, comprising commands which, when the computer program product is run by the control device (20) of claim 11, prompt the control device to carry out the method (100) of claim 8.

13. A computer-readable medium, comprising commands which, when the commands are run by the control device (20) of claim 11, prompt the control device to carry out the method (100) claim 8.

14. A bicycle (1), comprising the bicycle transmission (2) and the control device (20) of claim 11.
